(19) United States
(12) Patent Application Publication
(10) Pub. No.: US 2007/0052521 A1
(43) Pub. Date: Mar. 8, 2007

(54) MOUNTING APPARATUS FOR RADIO FREQUENCY IDENTIFICATION SYSTEM

(75) Inventors: Michael H. Beedles, Hendersonville, TN (US); Paul Scott Charlton, Mount Juliet, TN (US); Timothy Alan Charlton, Smyrna, TN (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: MICRO TRAK GPS, INC., Dallas, TX (US)

(21) Appl. No.: 11/469,831

(22) Filed: Sep. 1, 2006

Related U.S. Application Data
(60) Provisional application No. 60/714,140, filed on Sep. 2, 2005.

(51) Int. Cl. H04Q 5/22

(52) U.S. Cl. 340/10.1; 340/572.1; 340/572.8

(57) ABSTRACT

A mounting apparatus for a radio frequency identification system is disclosed. The mounting apparatus includes a base and a frame. The frame has an upper section that is adjustable relative to the lower section to provide different configurations such as heights, and capable of being separated into two or more of its component parts to facilitate storage, shipping (particularly shipping via commercial carriers such as UPS that have maximum container sizes and/or configurations), break down, mobility, adjustability, and the like. A translucent or transparent cover encloses the frame and RFID components to all visual access to the components therein. A system comprising two portals connected by bridge having an adjustable bridge.

### CROSS-REFERENCE TO RELATED APPLICATIONS

This application claims priority to the U.S. Provisional Application No. 60/714,140 filed Sep. 2, 2005, the contents of which are incorporated herein by reference in its entirety.

### BACKGROUND

It is generally known to provide for a radio frequency identification (RFID) system for non-contact communication of information (e.g., scanning, identification reading, etc.). Such known RFID systems provide a wireless environment configured to identify and record data information parameters associated with items that have a radio frequency (RF) sensitive tag or label. The RFID system may be used in any of a variety of environments, including manufacturing equipment applications, pharmaceuticals applications, medical applications, restaurant and food industry, and the like. For example, in a retail or warehouse environment, the user could bring a cart to a portal that houses the antennas and reader so that the items on the entire cart can scan and calculate all the items with the transponder (RFID tag).

Known RFID system typically comprise certain RFID electrical/electronic components and a mounting apparatus for the components. The RFID components are in communication with a database via a computer network, and typically include an antenna, a reader (e.g., reader, interrogator, transceiver, coder/decoder, etc.), an RFID tag or label (e.g., transponder, etc.). In response to the RFID tags communicating data to an antenna, the database captures the information from the transceiver and, upon comparing the information with a data base (e.g., an inventory manifest held in a computer readable medium), records handling of the item (e.g., transport, disposal, etc.). The mounting apparatus typically comprises a square or rectangular horizontal cross-section (i.e., section taken parallel to the floor).

However, such known radio frequency identification systems have several disadvantages including: custom manufacturing according to application and configuration; non-adjustability for use in different applications, shape configuration prone to being bumped or caught by movement around the system (e.g., transport vehicle such as a cart or forklift, or the like) and the like. Also some known systems do not have covers and the components are open to the environment.

### BRIEF SUMMARY

The above-identified deficiencies and drawback of current radio frequency identification (RFID) systems are overcome through example embodiments of the present invention. For example, embodiments described herein provide for an adjustable, configurable, and reconfigurable RFID framework. Note that this Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One embodiment of the invention relates to a radio frequency identification system comprising RFID components and a mounting apparatus. The mounting apparatus includes a base and a frame. The frame has an upper section that is adjustable relative to the lower section to provide different configurations such as heights, and capable of being separated into two or more of its component parts to facilitate storage, adjustability, shipping (particularly shipping via commercial carriers such as UPS that have maximum container sizes and/or configurations), break down, mobility, and the like. A translucent or transparent cover encloses the frame and RFID components to all visual access to the components and status lights therein.

Accordingly, some of the above embodiments advantageously provide a RFID system that may be adjustable, configured and/or reconfigured (both in the height of the portal and in the positioning of the components mounted on the mounting apparatus). Other embodiments also provide a RFID system with an adjustable height and/or spacing between component columns of a two-sided portal.

The present invention further relates to various features and combinations of features shown and described in the disclosed embodiments. Other ways in which the objects and features of the disclosed embodiments are accomplished will be described in the following specification or will become apparent to those skilled in the art after they have read this specification. Such other ways are deemed to fall within the scope of the disclosed embodiments if they fall within the scope of the claims which follow.

### BRIEF DESCRIPTION OF THE DRAWINGS

In order to describe the manner in which the above-recited and other advantageous features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example working environment for an RFID system;

FIG. 2A-F illustrate various components and adjustments of an RFID mounting apparatus in accordance with example embodiments;

FIG. 3 illustrates an example of a base unit of an RFID mounting apparatus in accordance with example embodiments;

FIG. 4 illustrates an example connector member of the middle section for the frame of an RFID portal in accordance with example embodiments;

FIG. 5 illustrates a clamp for a component bracket and other uses in accordance with example embodiments;

FIG. 6 illustrates an adjustable two-sided portal in accordance with example embodiments;

FIGS. 7 & 8 illustrate alternative adjustable frames with adjustable components in accordance with example embodiments; and

FIGS. 9A-E illustrate various cover designs in accordance with example embodiments.

### DETAILED DESCRIPTION

The present invention extends to methods and systems that provide an adjustable, configurable, and/or reconfigurable radio frequency identification (RFID) system. Accordingly, an (RFID) system for non-contact communication of information (e.g., scanning, identification reading, etc.) is shown in the FIGURES according to an exemplary embodiment.

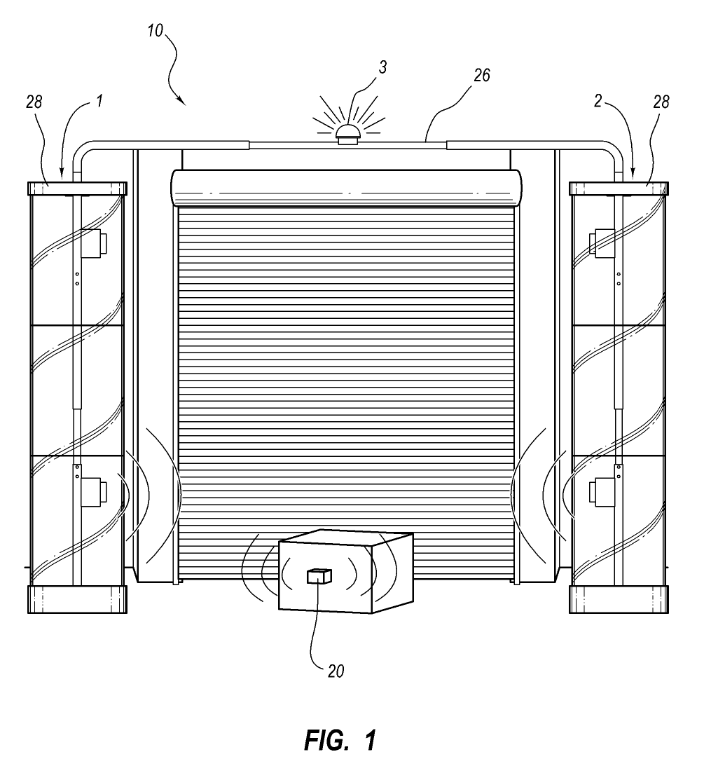

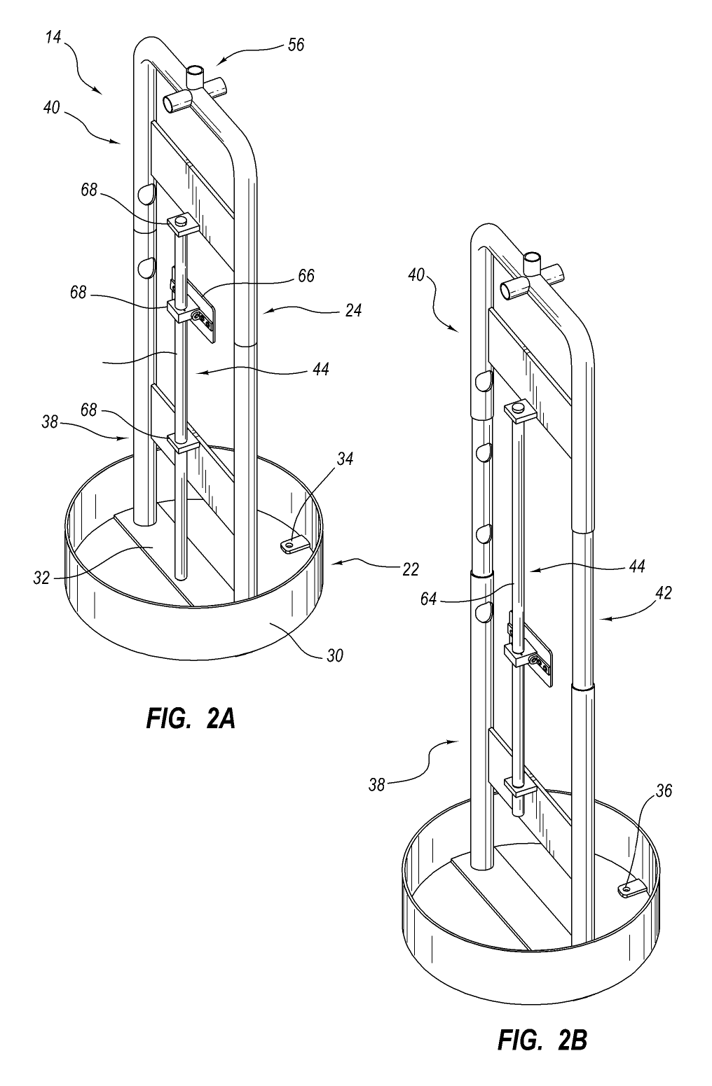

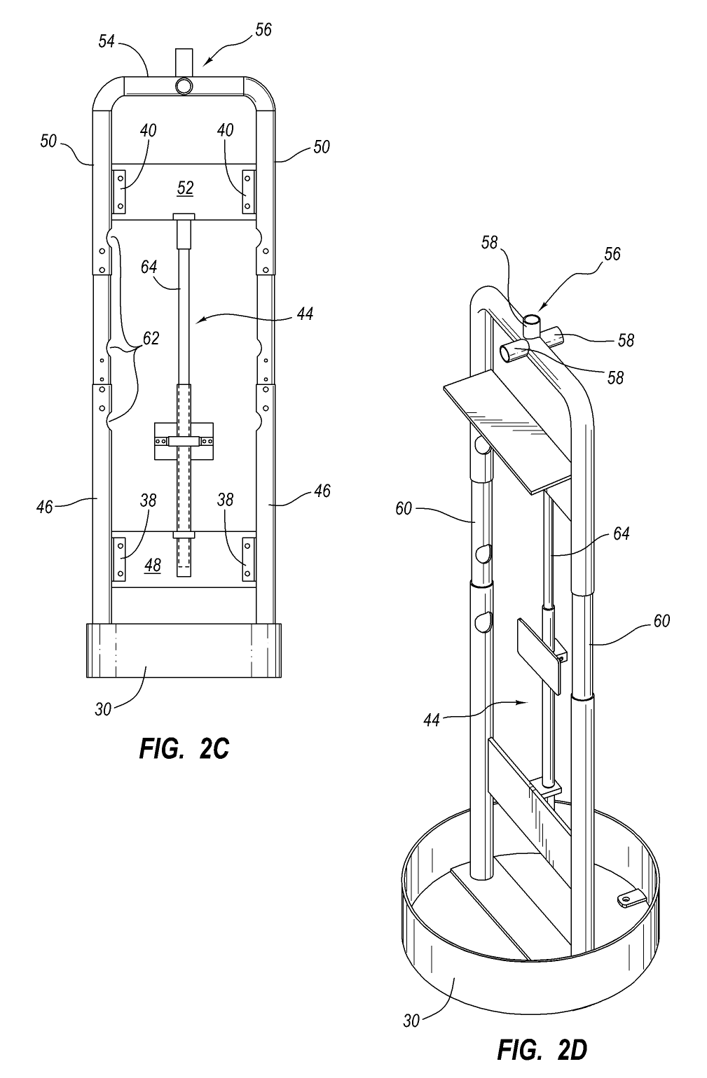

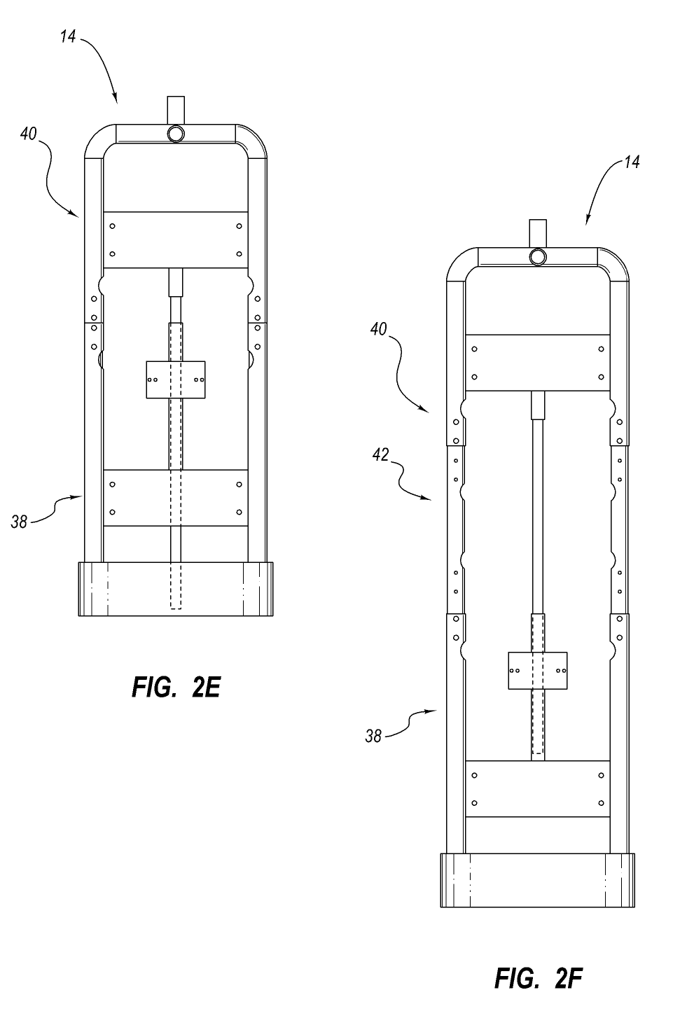

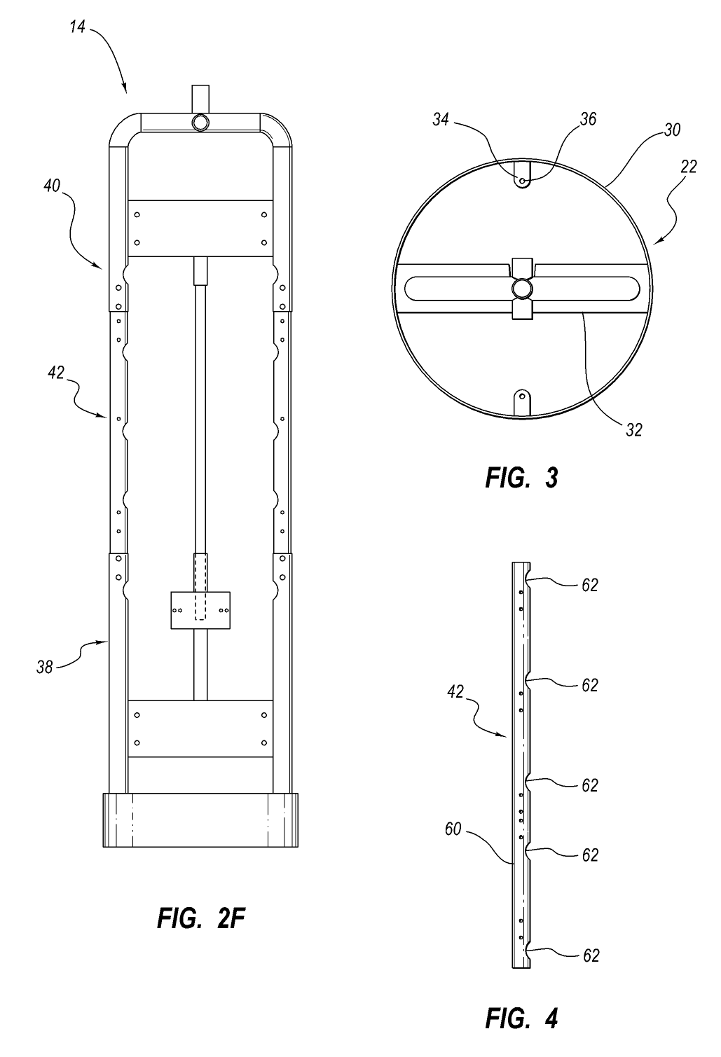

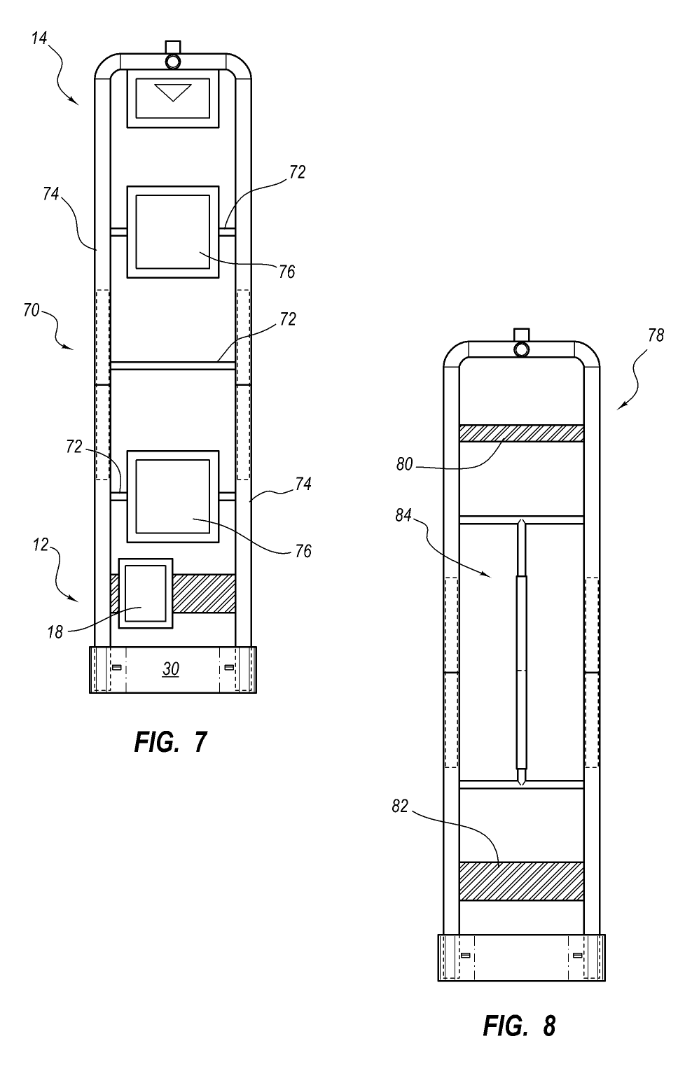

As shown in FIG. 1, The RFID system 10 provides a wireless environment configured to identify and transmit data information parameters associated with items that have a radio frequency (RF) sensitive tag or label 20. As shown, e.g., in FIGS. 2A and 7, the RFID system comprises RFID electrical/electronic components 12 (e.g., antenna 76, reader 18, etc.) and a mounting apparatus 14 for the components 12 (e.g., a fixture, support structure, framework, etc.). The RFID components 12 are in communication with a database (not shown) via a computer network (e.g., hard-wired, wireless, Internet, etc.). The RFID components 12 include an antenna 76, a reader 18 (e.g., interrogator, transceiver, coder/decoder, etc.), and an RFID tag or label 20 (e.g., transponder, etc. attached to an box or other item as shown in FIG. 1). In response to each of the RFID tags 20 communicating data to the antenna 16, the database captures the information from the transceiver and, upon comparing the information with the database (e.g., an inventory manifest held in a computer readable medium), records handling of the item (e.g., transport, disposal, etc.).

An RFID system generally will take the form of a single or one-sided portal, and a multi portal (e.g., a two-sided portal). In the one-sided portal, a single RFID column is positioned to be at on side of an area to be scanned for RFID information. In the two-sided portal (shown in FIG. 1 and FIG. 6), a pair of RFID columns 1 and 2 are spaced apart and coupled together by a cross member (shown as a bridge 26). The bridge 26 is coupled to a mount (shown as a tube) on the horizontal hollow member of the spaced apart RFID columns 1 and 2 and may be used to mount one or more additional antennas or a caution light 3. According to an exemplary embodiment, the bridge 26 comprises a pair of hollow members (generally L-shaped as shown in FIG. 6) connected by a connector 60 slidably engaged with the L-shaped hollow members. The width of the bridge 26 is adjustable (e.g., for different applications, mobility, etc.) by separating or moving together the members that has an adjustable width between the two columns 1 and 2.

The one or more antennas 76 are coupled to the mounting apparatus as described more fully below and shown in FIG. 7. Multiple antennas 76 may be mounted on each mounting apparatus 14 (e.g., as a vertical or horizontal array). Where multiple antennas are used, they may be arranged in off setting angular and positional increments relative to one another to increase or maximize effectiveness of the RFID scan. According to exemplary embodiments, any of a variety of angular and positional arrangements and orientation may be used by the mounting apparatus 14 to provide the desired RFID performance.

The reader 18 is configured to send and receive signals to the antennas 76 and is in communication with database. The reader 18 issues a radio frequency scan from the antennas 76 of the target area or three-dimensional space (e.g., a signal as screen created at a doorway, a conveyer belt, storage unit, etc.). Note that although a shipping dock is shown in FIG. 1 as using the RFID system, other well known uses are also contemplated herein, for example, retail store use, shopping center use, package distributing use, etc.

Regardless of the type of RFID system, the RFID tag 20 is coupled to an item (e.g., cargo, box, pallet, product, packaging, person, animal, etc.) and is electronically programmed with information for the particular application. The RFID tag 20 allows for additional information to be added and information to be stored about the tagged item (e.g., to enable the user to track carton or pallet level data, track assets, track vehicles, manage tractor trailer/containers and control inventory as well as personnel).

Referring now to FIGS. 2A-F one or more of the components are configured to be mounted or coupled to the mounting apparatus 14. The mounting apparatus 14 includes a base 22, a frame 24, a cross member or bridge 26 (if a multi sided portal as shown in FIG. 6), and an outer cover 28 (e.g., shown in FIG. 1). The mounting apparatus 14 is configured to be adjustable (e.g., configurable, reconfigurable, etc.) and capable of being separated into two or more of its component parts to facilitate storage, shipping (particularly shipping via commercial carriers such as UPS that have maximum container sizes and/or configurations), break down, mobility, and the like. FIGS. 2D-F illustrate various positions of an exemplary mounting apparatus. More specifically, FIG. 2D shows the mounting apparatus in a closed position where the upper section 40 and lower section 38 are in contact with one another. FIG. 2E shows the mounting apparatus in a mid-open position where the upper section 40 is partially separated from the lower section 38 by a mid section 42. Finally, FIG. 2F shows the mounting apparatus in a fully open position where the upper section 40 is fully separated from the lower section 38 by mid section 42. Note that although only three positions and relative separation of the upper section 40 from the lower section 38 is shown, any number of positions and height separations are contemplated herein.

Referring now to FIGS. 2A, 2B, and 3, the base 22 supports the frame 24 and may be configured to provide self-standing support (e.g., in lower traffic or mobile applications) or a fixed support (e.g., mounted to a floor such as in higher traffic or more secure applications). As shown from the top view in FIG. 3, the base 22 comprises an outer member 30 (shown as a circular ring member), an interior cross member or mounting plate 32. The circular outer member 30 is intended to reduce or minimize “catch points” where persons or objects passing near the portal can catch the portal and cause it to be damaged or be moved (out of alignment with the desired scanning area). The mounting plate 32 includes holes or slots for receiving fasteners (e.g., bolts, screws, rivets, etc.) for connecting to the frame 24. In other words, the frame 24 is separable from the base unit 22 in order to allow the portal 14 to be broken down into its various parts for ease in shipping, storing, moving, etc. One or more flange 34 may extend from the outer member 30 and/or from the mounting plate 32 and include holes 36 so that the portal can be fixedly mounted to the floor or other substrate (e.g., with fasteners, stakes, etc.). Note that although the base 22 shows a circular outer member 30 and mounting plate 32 for mounting the frame 24, other shapes and mechanisms for mounting the frame 24 are also contemplated herein. As such, any specific use of a particular type of base unit 22 as shown or described herein is used for illustrative purposes only and is not meant to limit or otherwise narrow the scope of embodiments herein unless explicitly claimed.

In any event, the frame 24 as shown, e.g., in FIG. 2A is coupled to and is supported by the base 22 (e.g., by fasteners, welds, etc.) and is configured to support one or more of the RFID components (e.g., one or more antennas 76, the reader 18, and other components of the RFID system). As shown, e.g., in FIG. 2B, the frame 24 extends generally along a vertical axis of the mounting apparatus 14 and comprises a lower portion or section 38, an upper portion or section 40, a middle portion or section 42, and a components support fixture 44.

As shown in FIG. 2C, the lower section 38 comprises a pair of spaced apart vertical members 46 and a spanning member 48 (e.g., brace, plate, etc.). According to an exemplary embodiment, these vertical members 46 are hollow members (e.g., tubes having a circular, square, rectangle, or other shape of cross-section) and are coupled to the base 22 and extend upwardly from the base, and are also coupled together by the spanning member 48. Note, however, that depending on whether or not the middle section 42 is slideably connected to the outside of the lower section 38, the vertical members 46 may also be solid.

The upper section 40 comprises a pair of spaced apart vertical members 50 coupled together by a spanning member 52 (e.g., brace, plate, etc.) and a top member 54. According to an exemplary embodiment, these vertical members 50 and the top member 54 are hollow members (e.g., tubes having a circular, square, rectangle, or other shape of cross-section). Similar to above, however, depending on whether or not the middle section 42 is slideably connected to the outside of the upper section 40, the vertical members 50 may also be solid. The top member 54 of the upper section 40 also includes a mount 56 for the bridge 26, the cover 28, or other structures. The bridge mount 56 includes a plurality of projections 58 (shown as tubes) that extend in various directions (e.g., at right angles from each other as shown in the Figures). Note, however, that angles other than right angles are also contemplated herein for compensating for such things as space considerations.

As shown in FIGS. 2C and 4, the middle section 42 comprises connector members 60 configured to slideably couple the lower section 38 to the upper section 40. According to an exemplary embodiment, the connectors 60 have the same shape of the hollow members 46 of the lower section 38 and the hollow members 50 of the upper section 40 and slide within the hollow members 46, 50. Note, however, that this does not necessarily need to be the case. For example, the hollow members 46 of the lower section 38 and the hollow members 50 of the upper section 40 may be round in shape, while the connectors 60 are square, triangular, or some other shape that will slideably fit inside the hollow members 46, 50. Note also, that combinations of shapes for the various parts of the mounting apparatus 14 are also available to the present invention. Accordingly, any particular shape and/or configuration of spaced apart vertical members 46, 50 and connectors 60 for the upper 40, lower 38, middle 42 sections, and bridge 26, are used herein for illustrative purposes and are not meant to limit or otherwise narrow the scope of embodiments unless explicitly claimed.

The sliding coupling arrangement between the connector 60 and the upper and lower sections 38, 40 provides a means for adjusting the height of the portal (e.g., for initial set up, for reconfiguring for a different application, for “tuning” of the RFID components or scan area screen, etc.). Alternatively, the connectors 60 receive the hollow members 46, 50 of the lower and upper sections 38, 40. After configuring and positioning the apparatus at the desired height, the hollow members 46, 50 of the lower and upper sections 38, 40 are connected to the connectors 60 by a fastener such as a bolt, pin, spring pin, buttons, or the like. The members 46, 50 and the connector 60 are preferably hollow for cable management and include a plurality of openings 62 defined by a flexible gasket or grommet (e.g., elastomer, rubber or other flexible material) that are spaced at intervals (e.g., 1 foot intervals) so that wiring for the RFID components may be brought out from the tubes near the components.

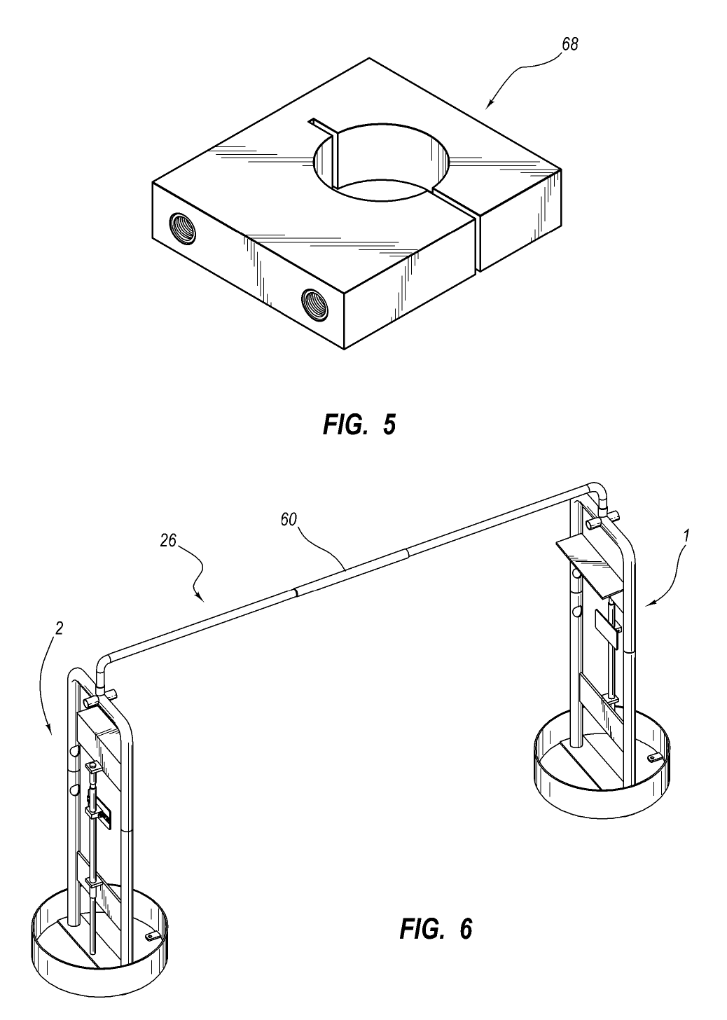

The component support fixture 44 shown, e.g., in FIGS. 2A and C includes a generally vertical member 64 (e.g., rod, tube, etc.), one or more component brackets 66, and a plurality of clamps 68 (e.g., similar to the claim 68 shown in FIG. 5). A clamp 68 is coupled to each of the lower and upper mounting plates 48, 52 to adjustably retain the vertical member 64. As the height of the frame 14 is adjusted, the engagement of between the clamp 68 and the vertical member 64 is also adjusted by loosening the clamps 68, moving the sections 38, 40, and tightening the clamps 68. Alternatively, as shown for example in FIGS. 2C and 2D, the vertical member 64 can be telescoped or slideably adjustable in a similar manner as other features herein described. The component brackets 66 are configured to retain one or more of the RFID components (e.g., antenna, reader, etc.). The component brackets 66 are coupled to the vertical member 64 by a clamp 68. The position of the component bracket 66 may be adjustable by loosening of the clamp 68, repositioning of the component bracket 66, and tightening of the clamp 68. According to an exemplary embodiment, the brackets 66 have a plurality of holes and slots to accommodate a variety of commercially available RFID components (e.g., provide a universal mounting system). According to an exemplary embodiment, a retaining feature is provided to improve the coupling between the clamps 68 and the vertical member such as a gasket, one or more teeth, or the like. According to other exemplary embodiments, any of a variety of mechanical, electrical, electronic devices may be coupled to the component support fixture, including without limitation a power strip, a display (e.g., stack lights, monitor, etc.). The display may be in communication with the reader, the database, the network, an enterprise resource planning software (ERP) system, the host system, or the like in order to provide information on status of the scanning. For example, stack lights may include red, yellow and green lights to signal whether the reader was able to obtain a good read of the RFID tags.

As shown in FIG. 1, 9C-9E, the cover 28 is coupled to the base 22 and/or the frame 24 and typically extends along the vertical axis. The cover 28 is configured to enclose and protect the frame 24, the RFID components 12, and the component support fixture. According to an exemplary embodiment, the cover 28 is made of a translucent or transparent material (see, e.g., cover section 115) so that the interior is visible to view the display, stack lights, and/or the RFID components. According to an exemplary embodiment, the cover 28 is made from a sheet of polycarbonate rolled to form a cylinder that slides over the mounting apparatus. Alternatively, the cover 28 may be made from a pair of polycarbonate sheets (e.g., cover section laid flat 100) and bolted together to promote easier break down for shipping, mobility, reconfiguring and the like. If a portal is being used for multiple applications that require different height adjustment of the mounting apparatus 14, the user may have multiple covers 100, 105, 110, 115 on hand to be used at the multiple heights (e.g., those covers shown as 105 height X′, 110 height 3′, 115 height 1′, etc.). Alternatively, a cover 28 with an alternative height may be used.

Note that other example embodiments provide for panels 100, 105, 110, 115 that can break the cover 28 into smaller, easier to manage pieces. The panels 100, 105, 110, 115 would typically go half-way around the portal 14 and attach to the side of the portal structure via a key/keyhole 120 or other similar mechanism. Each panel 100, 105, 110, 115 may have a plastic “frame” 95 on the left and right sides of each poly sheet 28 with bolt-head “keys” 125 protruding from the frame. The keys 125 fit into keyholes 120 cut into the portal's 14's side. The operator simply snaps the cover 28 down into place. To form a complete cylinder, the operator simply repeats the process with another panel 100, 105, 110, 115 on the opposite side. Because the panels 100, 105, 110, 115 only go halfway around, it's much easier for a single person to install and remove. Note, however, that other well known attachment mechanism are also contemplated herein.

If a technician needs access to the RFID equipment inside the portal 14, they can simply remove a single panel 100, 105, 110, 115 instead of the entire cover 28. The paneled cover 100, 105, 110, 115 adds additional flexibility because while the customer can attach enough panels 100, 105, 110, 115 to form a complete cylinder, they won't necessarily have to. If for instance a customer would like to mount the portal 14 on a wall, they can purchase just enough panels 100, 105, 110, 115 to cover one side of the portal while leaving the opposite side flat. A complete cylinder isn't necessary unless RFID antennas point away from both directions. This advantageously provides the customer with more pricing options as well. The pricing flexibility is important as the current cover 28 costs are nearly as much as the cost for the metal in the portal 14.

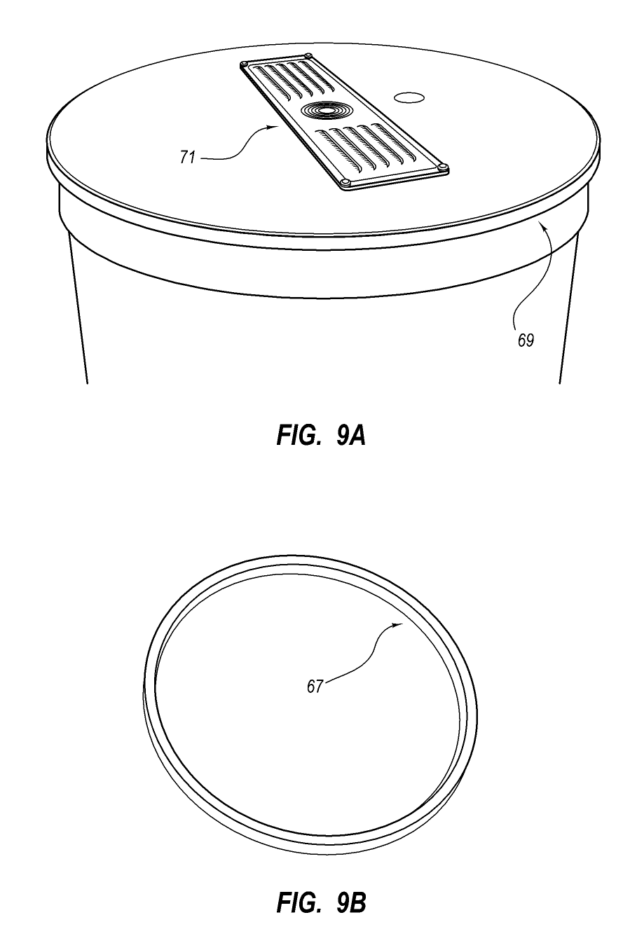

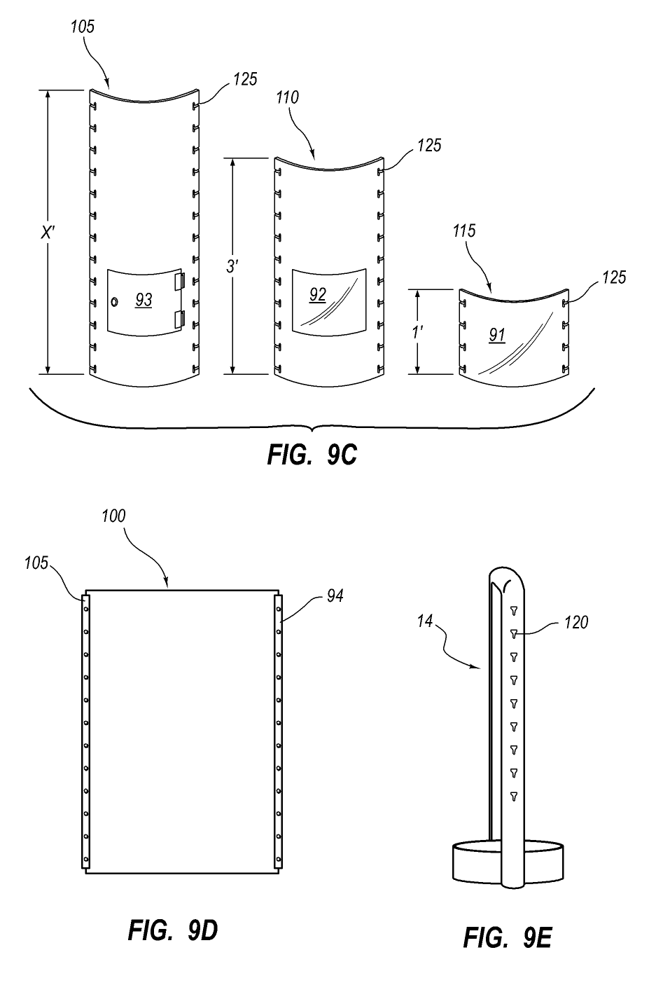

The cover 28 or panels 100, 105, 110, 115 may also be provided with an access door 93, 92 to provide access (physical and/or visual) to the RFID components. According to an exemplary embodiment shown in FIGS. 1, 9B and 9C, the cover may be comprised of two sections connected by a ring 67 located generally at the mid-point of the overall cover. The ring 67 comprises grooves in the top and bottom to received edges of the cover sections. Referring to FIGS. 1 and 9A, a top cap 69 with a vent 71 may also be provided and may be powered by a fan for ventilation.

According to an alternative embodiment shown in FIGS. 7 and 8, a frame 70 includes a plurality of generally horizontal members 72 coupled to vertical frame members 74. The horizontal members 72 are configured to support one or more of RFID components 12. The RFID components 12 are adjustably coupled to the horizontal members 72 to provide angular adjustment, for example, to an antenna 76 to adjust or modify the area being scanned. The mounting apparatus in FIG. 21 shows a frame 78, an upper mounting plate 80 (e.g., for the reader or other device), a lower mounting plate 82 (e.g., for the reader or other device), and a mounting member or rod 84 (e.g., for adjustable mounting of one or more antennas). The mounting rod includes horizontal and vertical members for flexibility in mounting of the one or more antennas.

While the disclosed embodiments have been illustrated as a component column designed for positioning near a doorway, the features of the disclosed embodiments have a much wider applicability. For example, the configurable/reconfigurable design is adaptable for other office, home, or educational products which employ radio frequency identification (e.g., conveyers, production lines, storage units or cabinets, any of a variety of validation points or the like). Further, the size of the various components and minimum and maximum height adjustments, and the width of the bridge can be widely varied depending on the desired performance and intended application. The RFID system generally will take the form of a single or one-sided portal, and a multi portal (e.g., a two-sided portal). In the one-sided portal, a single RFID column is positioned to be at on side of an area to be scanned for RFID information. In the two-sided portal, a pair of RFID columns are spaced apart and coupled together by an adjustable bridge.

The particular materials used to construct the exemplary embodiments are also illustrative. For example, extruded steel tubing is the preferred method and material for making the hollow members of the frame. Also, extruded polycarbonate is the preferred method and material for making the cover, but other materials can be used, including other thermoplastic resins such as polypropylene, high-density polyethylene, other polyethylenes, acrylonitrile butadiene styrene (“ABS”), polyurethane nylon, any of a variety of homopolymer plastics, copolymer plastics, plastics with special additives, filled plastics, etc. The materials used for the cover may be any of a variety flexible or rigid materials. Also, other molding operations may be used to form these components, such as injection molding, blow molding, rotational molding, etc.

It is important to note that the terms “reader,” “bracket,” “and “portal” are intended to be broad terms and not terms of limitation. These components may be used with any of a variety of products or arrangements and are not intended to be limited to use with doorway portal RFID applications.

It is also important to note that the construction and arrangement of the elements of the radio frequency identification system as shown in the preferred and other exemplary embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements show as multiple parts may be integrally formed, the operation of the interfaces may be reversed or otherwise varied, the length or width of the structures and/or members or connector or other elements of the system may be varied, the nature or number of adjustment positions provided between the elements may be varied (e.g. by variations in the number of engagement slots or size of the engagement slots or type of engagement). It should be noted that the elements and/or assemblies of the system may be constructed from any of a wide variety of materials that provide sufficient strength or durability, in any of a wide variety of colors, textures and combinations. Accordingly, all such modifications are intended to be included within the scope of the present inventions. Other substitutions, modifications, changes and omissions may be made in the design, operating conditions and arrangement of the preferred and other exemplary embodiments without departing from the spirit of the present inventions.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A radio frequency identification (RFID) mounting apparatus comprising:
a base unit for supporting the mounting apparatus; and
a frame extending generally along a vertical axis of the mounting apparatus and used to support one or more RFID components therein, wherein the frame includes an upper section, a middle section, and a lower section, which is coupled to the base unit, and wherein the upper section is adjustable relative to the lower section via the middle section.

2. The RFID mounting apparatus of claim 1, further including a cover for enclosing the frame and the one or more RFID components including one or more of an antenna, reader, or display, and wherein the cover is configured to be divided into different cover sections of a plurality of height sizes in order to accommodate changes to the adjustment of the upper section relative to the lower section.

3. The RFID mounting apparatus of claim 2, wherein at least one of the different cover sections includes a door, a transparent section, or both, for providing as visual access, physical access, or both, to the one or more RFID components.

4. The RFID mounting apparatus of claim 2, wherein the one or more different cover sections of different height sizes are coupled to the frame using one or more keys inserted into a plurality of keyholes along at least the upper and lower sections.

5. The RFID mounting apparatus of claim 1, wherein the lower section is able to be detached from the base unit for collapsing the mounting apparatus when facilitating in one or more of storage, shipping, breakdown, or mobility.

6. The RFID mounting apparatus of claim 1, wherein the base unit includes an outer member and an interior mounting plate used to connect the lower section thereto.

7. The RFID mounting apparatus of claim 6, wherein the outer member of the base unit is circular in order to reduce or minimize catch points where persons or objects passing near the RFID mounting apparatus can catch it and cause it to be damaged, moved, or both.

8. The RFID mounting apparatus of claim 1, wherein the frame further includes one or more component support fixtures, which are removable allowing the mounting apparatus to become collapsible for further facilitating in one or more of storage, shipping, breakdown, or mobility.

9. The RFID mounting apparatus of claim 1, wherein the middle section includes one or more connector members configured to slideably couple the lower section to the upper section.

10. The RFID mounting apparatus of claim 9, wherein the one more connector members have a similar shape of hollow members for both the lower section and the upper section and slide within the hollow members thereof.

11. A method for adjusting a radio frequency identification (RFID) mounting apparatus comprising:
obtaining the RFID mounting apparatus that includes a base unit for supporting the mounting apparatus and a frame extending generally along a vertical axis of the mounting apparatus and used to support one or more RFID components therein, and wherein the frame includes an upper section, a middle section, and a lower section coupled to the base unit; and
adjusting the upper section relative to the lower section via the middle section.

12. The method of claim 11, further comprising:
attaching a plurality of cover sections to the frame in order to enclose the frame and the one or more RFID components including one or more of an antenna, reader, or display, and wherein at least two of the plurality of cover sections vary in height sizes in order to accommodate changes to the adjustment of the upper section relative to the lower section.

13. The method of claim 12, further comprising:
opening a door, looking through a transparent section, or both, within one or more of the different cover sections in order to have visual access, physical access, or both, to the one or more RFID components.

14. The method of claim 12, wherein the one or more different cover sections are attached to the frame using one or more keys inserted into a plurality of keyholes along at least the upper and lower sections.

15. The method of claim 11, further comprising:
detaching the lower section from the base unit for collapsing the mounting apparatus when facilitating in one or more of storage, shipping, breakdown, or mobility.

16. The method of claim 1, further comprising:
removing one or more component support fixtures from the frame in order to allow the mounting apparatus to become collapsible for further facilitating in one or more of storage, shipping, breakdown, or mobility.

17. A two-sided radio frequency identification (RFID) portal comprising:
a first RFID column including a first base unit for supporting the first RFID column and a first frame extending generally along a vertical axis of the first RFID column and used to support one or more RFID components therein, wherein the first frame includes a first upper section, a first middle section, and a first lower section, which is coupled to the first base unit, and wherein the first upper section is adjustable relative to the first lower section via the first middle section;
a second RFID column including a including a second base unit for supporting the second RFID column and a second frame extending generally along a vertical axis of the second RFID column and used to support one or more RFID components therein, wherein the second frame includes a second upper section, a second middle section, and a second lower section, which is coupled to the second base unit, and wherein the second upper section is adjustable relative to the second lower section via the second middle section; and
a bridge placed horizontal to the first and second RFID columns in order to both attach and separate them, wherein the bridge is adjustable in order to adjust the width between the first and second RFID columns.

18. The two-sided RFID portal of claim 17, wherein the bridge includes a pair of hollow members each slideably engaged via a connector that allows the width adjustment between the separation of the first and second RFID columns.

19. The two-sided RFID portal of claim 18, wherein the connector has a similar shape as the pair of hollow members.

20. The two-sided RFID portal of claim 17, further including a first and second cover for enclosing the first and second frames and the one or more RFID components therein including one or more of an antenna, reader, or display, and wherein the first and second covers are configured to be divided into different cover sections of a plurality of height sizes in order to accommodate changes to the adjustment of the first and second upper sections relative to the first and second lower sections, respectively.
